(19) United States
(12) Patent Application Publication
(10) Pub. No.: US 2004/0237731 A1
(43) Pub. Date: Dec. 2, 2004

(54) Adjustable wrench

(76) Inventor: Tae-Hwan Ha, Seoul (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/492,492

(22) PCT Filed: Oct. 7, 2002
(86) PCT No.: PCT/KR02/01865

(30) Foreign Application Priority Data
Oct. 12, 2001 (KR) 2001-0031158U

(51) Int. Cl. B25B 13/00

(52) U.S. Cl. 81/186; 81/165

(57) ABSTRACT

Utility is enhanced by an adjustable wrench including a fixed jaw fixedly formed at the body, an adjustable jaw adjustable relative to the fixed jaw, and a fastening unit disposed at one or each of the fixed jaw and the adjustable jaw, the fastening unit including a plurality of sprags such that one end of each of the sprags is linearly aligned facing the opposite jaw.

### BACKGROUND OF THE INVENTION

(a) Field of the Invention

The present invention relates to a wrench, and more particularly, to an adjustable wrench that has a fixed jaw and an adjustable jaw that is adjustable with respect to its distance to the fixed jaw, such as a crescent wrench and a pipe wrench.

(b) Description of the Related Art

A conventional adjustable wrench such as a crescent wrench and a pipe wrench is a tool for manipulating a fastener of a polygonal circumference (referred to as “polygonal fastener” hereinafter) such as a bolt and a nut, or for threading in/out a material of a circular circumference such as a pipe.

The words “adjustable wrench” in the field are sometimes used for designating only the crescent wrench, however, in this specification, it is used for designating any kind of wrench that has an adjustable jaw, including the crescent wrench and pipe wrench.

According to an adjustable wrench of the prior art, a fixed jaw is formed at a body, and an adjustable jaw is provided at the body such that a relative distance between the fixed and adjustable jaws can be varied. The adjustable jaw is usually screw-engaged with the body, and the distance between the two jaws is varied by rotating a nut on the screw.

A fastener is inserted between fastening surfaces of the fixed and adjustable jaws, and it is gripped or released as the adjustable wrench adjusting nut is rotated.

Fastening surfaces of a crescent wrench according to the prior art are usually formed to be parallel, and between the fastening surfaces, a fastener of polygonal circumference, for example, a bolt with a polygonal head and a nut with a polygonal exterior (referred to as “polygonal bolt and nut” respectively hereinafter), is inserted and manipulated.

Fastening surfaces of a pipe wrench according to the prior art are formed with a predetermined angle, and each of the fastening surfaces is sharply corrugated such that jaws of the pipe wrench can tightly hold a pipe when the pipe wrench is rotated with the pipe located between the jaws thereof.

When a polygonal fastener is manipulated with such a crescent wrench of the prior art, clearance may occur because of clearance intrinsically resident in the screw engagement itself and similar reasons, and therefore a conventional crescent wrench is not tightly fitted to a fastener. In this case where clearance occurs, edges of a polygonal fastener may wear when a large torque is applied. When the edges have worn substantially, further applying of torque may be impossible.

When a pipe is manipulated with such a pipe wrench of the prior art, the exterior of the pipe is easily damaged by the corrugation formed on the fastening surface of the pipe wrench.

In addition, when a fastener or a pipe (a fastener and a pipe are collectively referred to as a “fastener” hereinafter) is manipulated with such an adjustable wrench, inconvenience of engaging and disengaging the wrench from the fastener is incurred at each stroke of tightening or loosening the fastener. Therefore, it is difficult to manipulate a fastener in a circumstance such that a space to rotate a wrench is small.

### SUMMARY OF THE INVENTION

Therefore, the motivation for the present invention is to provide non-limiting advantages of enhancing utility of an adjustable wrench due to reduced clearance.

An exemplary adjustable wrench useful with the present invention includes a fixed jaw fixedly formed at the body, an adjustable jaw adjustable relative to the fixed jaw, and a fastening unit disposed at one or each of the fixed jaw and the adjustable jaw, the fastening unit comprising a plurality of sprags such that ends of each of the sprags are linearly aligned facing the opposite jaw.

The fastening unit is preferably disposed at each of the fixed jaw and the adjustable jaw, and in this case, a groove is preferably formed at each of the fixed and adjustable jaws and the fastening unit is inserted into the groove. The sprags of the opposing fastening units are preferably aligned in parallel or with a predetermined angle.

In a further embodiment, the fastening unit further includes a plate spring for positioning the sprags. In this case, both lateral sides of the sprag are preferably concave, a plurality of receiving holes are preferably formed at the plate spring, each of the sprags is preferably inserted through a receiving hole of the plate spring, and a supporting projection is preferably formed at the receiving hole of the plate spring such that the support projection supports the concave lateral side.

In another further embodiment, at least one end of each of the sprags is asymmetrically convex. Preferably, the other ends of the sprags are symmetrically convex.

In a further embodiment, upper and lower edges of at least one end of each of the sprags are rounded.

In another further embodiment, the fastening unit further includes an inner member and an outer member for positioning the sprags, a plurality of receiving holes are respectively formed at the inner member and the outer member, the inner member is disposed toward an opposite jaw from the plate spring, and the outer member is disposed toward the opposite side of the inner member from the plate spring.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is an exploded perspective view of an adjustable wrench according to a first preferred embodiment of the present invention;

FIG. 2 is a partial cross-sectional view of an adjustable wrench according to a first preferred embodiment of the present invention;

FIG. 3 is an exploded perspective view of a fastening unit of an adjustable wrench according to first and second preferred embodiments of the present invention;

FIG. 4 illustrates planar and lateral views of a sprag of an adjustable wrench according to first and second preferred embodiments of the present invention;

FIG. 5 illustrates a power stroke of an adjustable wrench according to first and second preferred embodiments of the present invention;

FIG. 6 illustrates a free stroke of an adjustable wrench according to first and second preferred embodiments of the present invention; and

FIG. 7 is an exploded perspective view of an adjustable wrench according to a second preferred embodiment of the present invention.

### DETAILED DESCRIPTION OF THE PREFERRED EMBODIMENTS

A preferred embodiment of the present invention will hereinafter be described in detail with reference to the accompanying drawings.

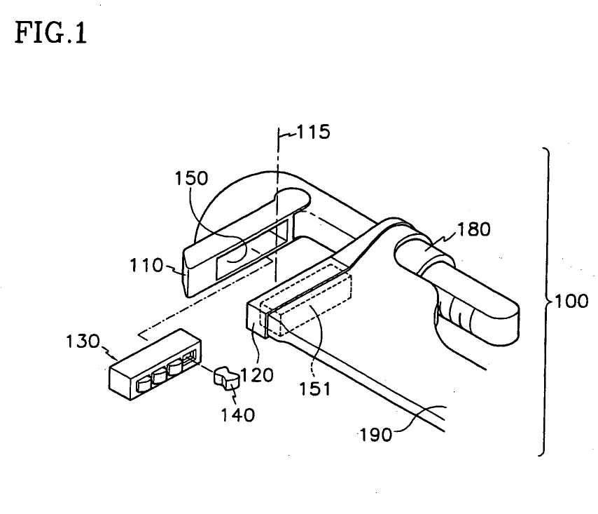

FIG. 1 is an exploded perspective view of an adjustable wrench according to a first preferred embodiment of the present invention.

As shown in FIG. 1, an adjustable wrench 100 according to a first preferred embodiment has a body 190, a fixed jaw 120 fixedly formed at the body 190, an adjustable jaw 110 adjustable relative to the fixed jaw 120, and a fastening unit 130 disposed at one or each of the fixed jaw 120 and the adjustable jaw 110.

The adjustable jaw 110 is screw-engaged with the body 190 through an adjusting nut 180, such that a distance to the fixed jaw 120 is varied by rotating the adjusting nut 180.

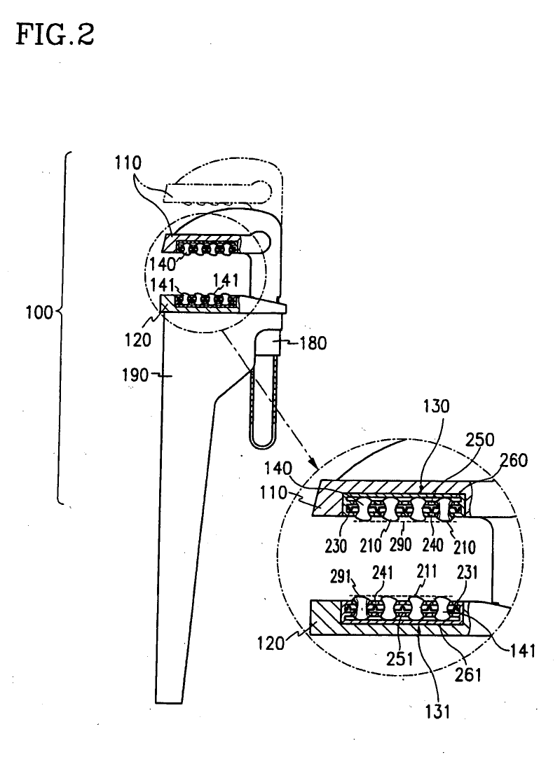

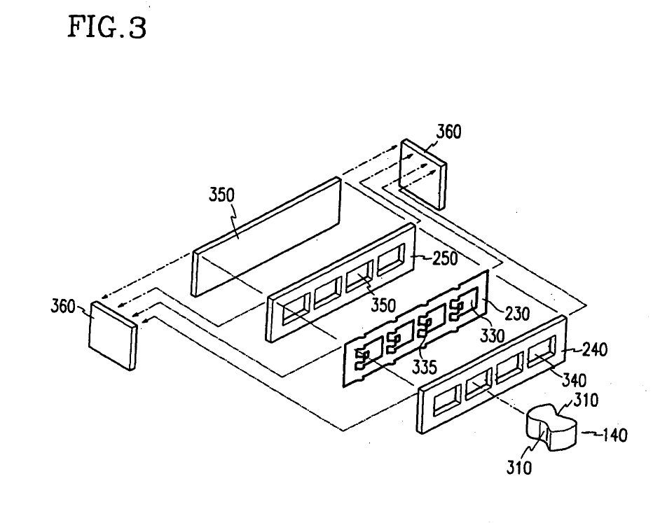

The fastening unit 130 includes a plurality of sprags 140 as shown in FIG. 1, and the fastening unit 130 is shown in further detail in FIGS. 2 and 3.

FIG. 2 is a partial cross-sectional view of an adjustable wrench according to a first preferred embodiment of the present invention, the cross-section of the adjustable and fixed jaws 110 and 120 being perpendicularly to an axis 115. As shown in FIG. 2, fastening units. 130 and 131 are respectively disposed at the adjustable and fixed jaws 110 and 120.

Grooves 150 and 151 are formed respectively at the adjustable and fixed jaws 110 and 120 as shown in FIG. 1, and the fastening units 130 and 131 are inserted in the corresponding grooves 150 and 151 as shown in FIG. 2.

The fastening units 130 and 131 respectively include a plurality of sprags 140 and 141.

Respective ends 210 and 211 of the sprags 140 and 141 are linearly aligned, forming respective lines 290 and 291 in FIG. 2, facing an opposite jaw.

More specifically, the sprags 140 of the fastening unit 130 disposed at the adjustable jaw 110 protrude toward the fixed jaw 110, and the sprags 141 of the fastening unit 131 disposed at the fixed jaw 120 protrude toward the adjustable jaw 120.

The alignment line 290 of the sprags 140 disposed at the adjustable jaw 110 and the alignment line 291 of the sprags 141 disposed at the fixed jaw 120 may be parallel or form a predetermined angle.

The fastening units 130 and 131 respectively further include plate springs 230 and 231, inner members 240 and 241, and outer members 250 and 251, each for positioning the sprags 140 and 141.

The plate springs 230 and 231 are respectively disposed in the vicinity of a central line of the sprags 140 and 141, the inner members 240 and 241 are respectively disposed toward opposite jaws 120 and 110 from the central line, and the outer members 250 and 251 are disposed at the opposite side of the inner members 240 and 241 from the central line, such that they are disposed in the order of the inner members 240 and 241, the plate springs 230 and 231, and the outer members 250 and 251 from the axis 115 shown in FIG. 1.

The inner and outer members 240 and 250 and the inner and the outer members 241 and 251 are respectively connected to the cases 260 and 261, and the cases 260 and 261 tightly contact interior walls of the grooves 150 and 151 of the adjustable and fixed jaws 110 and 120.

FIG. 3 is an exploded perspective view of a fastening unit 130, and the fastening unit 130 of the adjustable jaw 110 is hereinafter described in detail with reference to FIG. 3.

Further detailed features of the fastening unit 131 are obvious and are clearly understood from the description of the fastening unit 130, because the fastening unit 131 is symmetrical to the fastening unit 130.

A plurality of receiving holes 330, 340, and 350 are respectively formed, at corresponding positions, at each of the plate spring 230, inner member 240, and outer member 250.

When the plate spring 230, the inner member 240, and the outer member 250 are assembled, the sprag 140 is inserted into the corresponding holes 330, 340, and 350.

In order to receive the sprags 140, widths of the receiving holes 330, 340, and 350 are formed larger than the width of the sprag 140.

As shown in FIG. 3, both lateral sides 310 of the sprag 140 are concave in the vicinity of its center, and a supporting projection 335 is formed at the receiving hole 330 of the plate spring 230 such that the support projection 335 supports the concave lateral side 310.

Therefore, when the sprag 140 has been inserted into the plate spring 230, the supporting projection 335 supports the concave lateral side 310 and prevents separation of the sprag 140 from the fastening unit 130.

In FIG. 3, a back plate 350 and a side wall 360 of the case 260, the inner member 240, and the outer member 250 are all separated for better understanding of their relationship, however it is preferable that they are fixed to one another as indicated in FIG. 2.

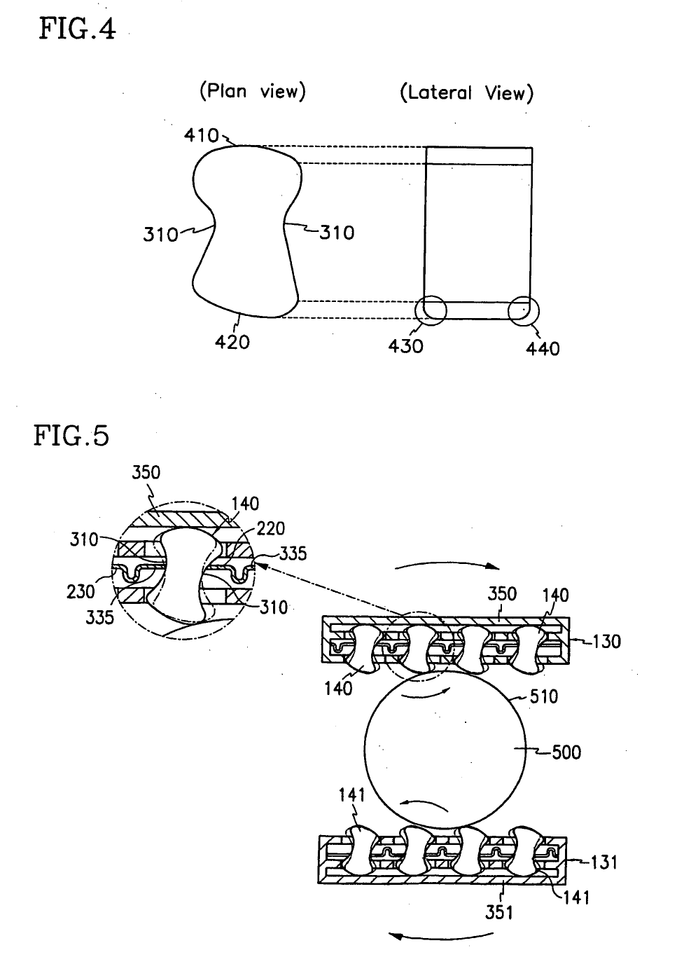

The shape of the sprag 140 is described in further detail with reference to FIG. 4.

FIG. 4 illustrates planar and lateral views of the sprag 140, where an upward direction in FIG. 4 is a direction toward the adjustable jaw 110, and a downward direction is a direction toward an opposite jaw, that is, the fixed jaw 120.

As shown in the planar view of FIG. 4, an upper end 410, that is, an end toward the adjustable jaw 110, is symmetrically convex, and a lower end 420, that is, an end toward the fixed jaw 120, is asymmetrically convex. Accordingly, the length between the upper and lower ends 410 and 420 is varied according to the angle by which the sprag 140 is aligned.

Upper and lower edges 430 and 440 of the lower end 420 of the sprag 140 are rounded such that a fastener such as a bolt and a nut can be easily inserted between the fastening units 130 and 131.

A fastener can be easily inserted between the fastening units 130 and 131 even in the case that the distance between the lines 290 and 291 formed by ends of the sprags 140 and 141 is slightly smaller than the circumference of the fastener.

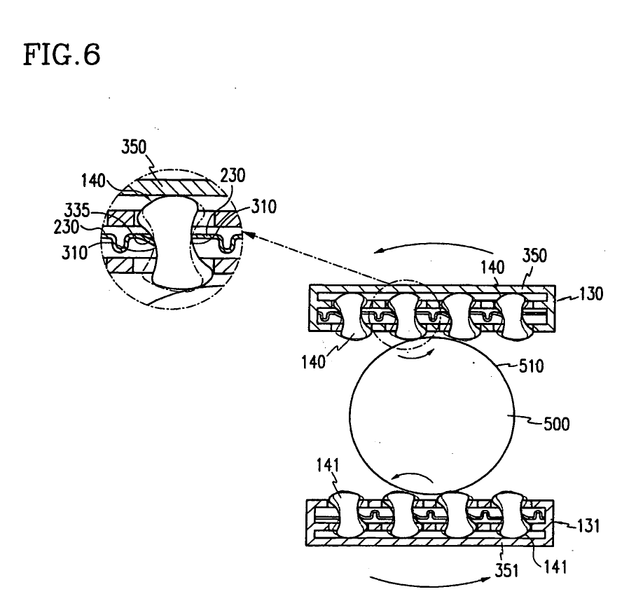

Operation of the adjustable wrench 100 of the first embodiment is hereinafter described in detail with reference to FIGS. 5 and 6.

In order to manipulate a fastener 500 using the wrench 100, the fastener 500 is inserted between the fastening units 130 and 131, and the adjustable jaw 110 is adjusted such that the fastener 500 is tightly fitted between the fastening units 130 and 131. Accordingly, a circumference 510 of the fastener 500 contacts the ends 420 of the sprags 140, and the ends 410 of the sprags 140 contact an interior surface of the jaw 110, that is, the back plate 350 of the case 260.

The shape of the circumference 510 of the fastener 500 does not matter, and it can be either circular or polygonal regardless of its number of angles, although the circumference of the fastener 500 is shown to be circular.

When the wrench 100 is rotated in a clockwise direction as shown in FIG. 5, the sprag 140, being in contact with the circumference 510 of the fastener 500 and the back plate 350 of the case 260, receives a clockwise rotating force because of the friction of the contact surfaces.

If rotated in the clockwise direction, the distance between the far ends 410 and 420 increases, but the sprag 140 cannot rotate in the clockwise direction because the case 260, the jaw 110, and the fastener 500 are rigid bodies. Therefore, the sprag 140 becomes more tightly jammed between the back plate 350 of the case 260 and the fastener 500.

Operation of the sprags 141 of the fixed jaw 120 in the case that the wrench 100 is rotated is obvious and can be clearly understood from the above description related to the operation of the sprags 140 of the adjustable jaw 110.

Therefore, the plurality of sprags 140 and 141 can hold the fastener 500 with a sufficient strength, and accordingly they can transmit a sufficiently large torque to the circumference 510 of the fastener 500.

Although FIG. 5 illustrates a case wherein a torque in a clockwise direction is applied, it also provides an understanding of the case wherein a torque in a counterclockwise direction is applied, because in order to apply a counterclockwise torque, the wrench 100 can be simply turned over.

According to the operation described above, the fastener 100 can be tightened or loosened.

Such forcing and rotating the fastener 500 by a degree is referred to as a “power stroke” hereinafter. Repeated application of the power stroke to the fastener 500 enables tightening or loosening of the fastener 500 to a desired position.

In order to repeatedly apply the power stroke without disengaging the wrench 100 from the fastener 500, the wrench 100 is rotated in the direction opposite to that of the power stroke (with respect to the example of a power stroke shown in FIG. 5, in a counterclockwise direction). Such rotating of the wrench 100 in the direction reverse to the power stroke is referred to as “free stroke” hereinafter.

Operation of the wrench 100 in the free stroke is hereinafter described in detail with reference to FIG. 6.

When the wrench 100 is rotated in a counterclockwise direction as shown in FIG. 6, the sprag 140, being in contact with the circumference 510 of the fastener 500 and the back plate 350 of the case 260, receives counterclockwise rotating force because of the friction of contact surfaces.

Therefore, the sprag 140 is forced to be released from the tightly jammed state between the back plate 350 and the fastener 900.

In this case, the supporting projection 335 that supports the concave lateral side 310 of the sprag 140 bends toward the fastener 500 as shown in FIG. 6, and the sprag 140 receives clockwise repositioning torque from the bended projection 335. Accordingly, the sprag 140 keeps in contact with the circumference 510 of the fastener 500 and the back plate 350 of the case 260 even when the wrench 100 is rotated in the counterclockwise direction.

Operation of the sprags 141 of the fixed jaw 120 in the case of a free stroke is obvious and can be clearly understood from the above description related to the operation of the sprags 140 of the adjustable jaw 110.

Therefore, when the wrench 100 is rotated again in a clockwise direction, no free play of the wrench 100 occurs, and the torque is immediately transmitted to the fastening unit 130 and subsequently to the fastener 500.

Because free play does not occur during repetition of the power stroke and the free stroke, the fastener 500 can be more easily tightened or loosened even when the space for operating the wrench 100 is very small due to nearby obstacles.

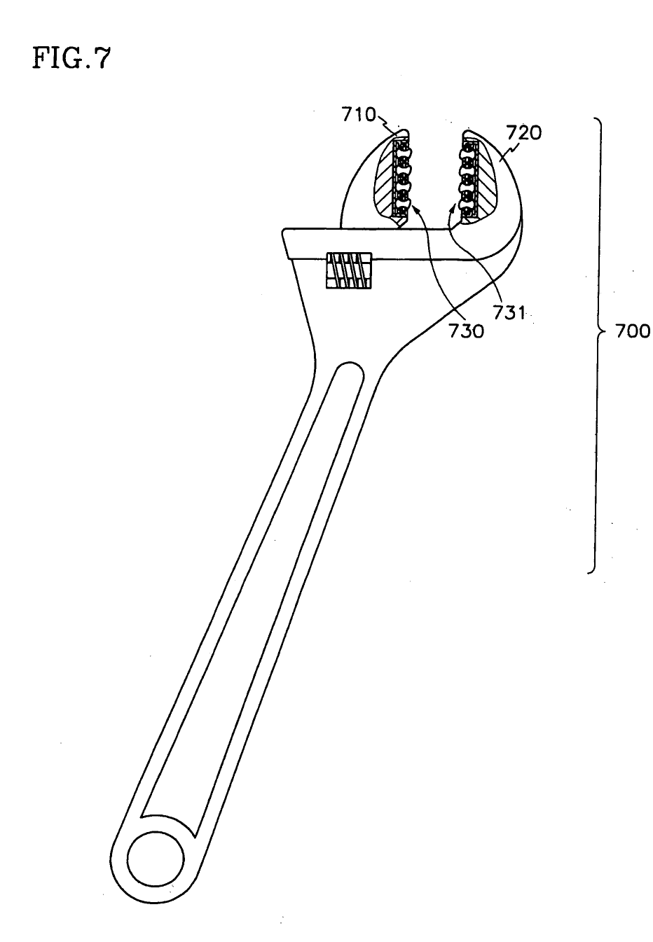

FIG. 7 is related to an adjustable wrench according to a second preferred embodiment of the present invention.

Whereas the first preferred embodiment is based on a conventional pipe wrench, the second preferred embodiment is based on a crescent wrench.

Like the first embodiment, an adjustable wrench 700 of the second embodiment has an adjustable jaw 710 and a fixed jaw 720. Fastening units 730 and 731 of the adjustable and fixed jaws 710 and 720 can be embodied the same as above-described regarding fastening units 130 and 131 of an adjustable wrench 100 according to the first embodiment.

According to preferred embodiments of the present invention, damage to a circumference of a fastener can be reduced. Furthermore, free play does not occur during repetition of the power stroke and the free stroke. Accordingly, a fastener can be more easily tightened or loosened even when the space for operating an adjustable wrench is very small due to nearby obstacles.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An adjustable wrench having a body, said adjustable wrench comprising:
a fixed jaw fixedly formed at the body;
an adjustable jaw adjustable relative to the fixed jaw; and
a fastening unit disposed at one Or each of the fixed jaw and the adjustable jaw,
the fastening unit comprising a plurality of sprags such that one end of each of the sprags is linearly aligned facing the opposite jaw.

2. The adjustable wrench of claim 1, wherein the fastening unit is disposed at each of the fixed jaw and the adjustable jaw.

3. The adjustable wrench of claim 2, wherein a groove is formed at each of the fixed and adjustable jaws and the fastening unit is inserted in the groove.

4. The adjustable wrench of claim 1, wherein the fastening unit further comprises a plate spring for positioning the sprags.

5. The adjustable wrench of claim 4, wherein:
both lateral sides of the sprag are concave;
a plurality of receiving holes are formed at the plate spring;
each sprag is inserted through a receiving hole of the plate spring; and
a supporting projection is formed at the receiving hole of the plate spring such that the support projection supports the concave lateral side.

6. The adjustable wrench of claim 1, wherein at least one end of each sprag is asymmetrically convex.

7. The adjustable wrench of claim 6, wherein at least one end of each sprag is symmetrically convex.

8. The adjustable wrench of claim 1, wherein upper and lower edges of at least one end of each sprag are rounded.

9. The adjustable wrench of claim 1, wherein:
the fastening unit further comprises an inner member and an outer member for positioning the sprags;
a plurality of receiving holes are respectively formed at the inner member and the outer member;
the inner member is disposed toward an opposite jaw from the plate spring; and
the outer member is disposed opposite the inner member from the plate spring.

10. The adjustable wrench of claim 3, wherein the sprags of the opposing fastening units are aligned in parallel.

11. The adjustable wrench of claim 3, wherein the sprags of the opposing fastening units are aligned with a predetermined angle.
